(19) United States
(12) Patent Application Publication
(10) Pub. No.: US 2014/0049398 A1
(43) Pub. Date: Feb. 20, 2014

(54) INDICATOR SYSTEM FOR AN ENERGIZED CONDUCTOR INCLUDING AN ELECTRET AND AN ELECTROLUMINESCENT INDICATOR

(71) Applicants: John A. KOVACICH, Waukesha, WI (US); Jerry H. SCHROEDER, Allenton, WI (US); Carl ANDERSON, Kenosha, WI (US); John TRUBLOWSKI, Troy, MI (US)

(72) Inventors: John A. KOVACICH, Waukesha, WI (US); Jerry H. SCHROEDER, Allenton, WI (US); Carl ANDERSON, Kenosha, WI (US); John TRUBLOWSKI, Troy, MI (US)

(21) Appl. No.: 13/588,632

(22) Filed: Aug. 17, 2012

(51) Int. Cl. G08B 21/00

(52) U.S. Cl. 340/660

(57) ABSTRACT

An indicator system for an alternating current power bus includes an electret operatively associated with the alternating current power bus. The electret has an output with an alternating current voltage when the alternating current power bus is energized. A rectifier includes an input electrically interconnected with the output of the electret and an output having a direct current voltage responsive to the alternating current voltage of the output of the electret. An electroluminescent indicator includes an input electrically interconnected with the output of the rectifier and an indication output responsive to the direct current voltage of the output of the rectifier. A number of capacitors are electrically connected in parallel with the input of the electroluminescent indicator.

### CROSS-REFERENCE TO RELATED APPLICATIONS

This application is related to commonly assigned, copending U.S. patent application Ser. No. 13/241,862, filed Sep. 23, 2011, entitled “Power System Including An Electret For A Power Bus”; and commonly assigned, copending U.S. patent application Ser. No. 13/241,770, filed Sep. 23, 2011, entitled “System Including An Indicator Responsive To An Electret For A Power Bus”.

### BACKGROUND

1. Field

The disclosed concept pertains generally to power bus apparatus and, more particularly, to power systems including an alternating current power bus. The disclosed concept also pertains to indicator systems for an alternating current power bus.

2. Background Information

Inside of electrical control centers, as well as other electrical environments, there are bus bar wiring conductors and lugged cable connection conductors, as well as conductor taps for three-phase power. This is true regardless whether the corresponding electrical product is for low-voltage or for medium-voltage.

Maintenance personnel can be harmed when accidentally touching energized surfaces of power bus bars.

Electrical sensors of various types are used to detect the current flowing through a conductor. Such sensors include, for example, a single Hall effect sensor that produces an output voltage indicative of the current magnitude as well as more conventional current sensors such as a shunt resistor or a current transformer.

Hall effect devices have been used to sense variations in magnetic flux resulting from a flow of current through a conductor. Some of these known devices have used a flux concentrator to concentrate magnetic flux emanating from the flow of current through the conductor. It has previously been suggested that electrical current sensing apparatus could be constructed in the manner disclosed in U.S. Pat. Nos. 4,587,509; and 4,616,207.

It is also known to measure the current in a conductor with one or two appropriately placed Hall sensors that measure flux density near the conductor and to convert the same to a signal proportional to current. See, for example, U.S. Pat. Nos. 6,130,599; 6,271,656; 6,642,704; and 6,731,105.

U.S. Pat. No. 7,145,322 discloses a power bus current sensor, which is powered by a self-powered inductive coupling circuit. A sensor senses current of the power bus. A power supply employs voltage produced by magnetically coupling the power bus to one or more coils, in order to power the sensor and other circuitry from flux arising from current flowing in the power bus.

U.S. Patent Application Pub. No. 2007/0007968 discloses a system for monitoring an electrical power system including one or more transducer units, each of which has a current measuring device and a voltage measuring device coupled to a respective one of the phase conductors of the power system, and a transducer wireless communications device. The transducer unit includes a battery for providing power to the components thereof. The battery is connected to a trickle charger, which, in turn, is electrically coupled to a phase conductor. The trickle charger is a known parasitic power charger that draws power from the phase conductor and uses it to charge the battery.

A known prior proposal for monitoring a bus bar wiring conductor employs a current transformer to harvest energy or an associated signal, through coupling to the magnetic field caused by current flowing through the conductor. However, if a load is not connected to the conductor, and, thus, no current is flowing, then a current transformer (or magnetic coupling) will not function.

There is room for improvement in indicator systems for a power bus.

### SUMMARY

This need and others are met by embodiments of the disclosed concept, which provide a system for an alternating current power bus in which a number of electrets are operatively associated with the alternating current power bus, and an electroluminescent indicator has an input electrically interconnected with the number of electrets and an output responsive thereto.

In accordance with one aspect of the disclosed concept, an indicator system for an alternating current power bus comprises: an electret operatively associated with the alternating current power bus, the electret comprising an output having an alternating current voltage when the alternating current power bus is energized; a rectifier comprising an input electrically interconnected with the output of the electret and an output having a direct current voltage responsive to the alternating current voltage of the output of the electret; an electroluminescent indicator comprising an input electrically interconnected with the output of the rectifier and an indication output responsive to the direct current voltage of the output of the rectifier; and a number of capacitors electrically connected in parallel with the input of the electroluminescent indicator.

In accordance with another aspect of the disclosed concept, an indicator system for an alternating current power bus comprises: a plurality of electrets operatively associated with the alternating current power bus, the electrets comprising an output having an alternating current voltage when the alternating current power bus is energized; and an electroluminescent indicator comprising an input electrically interconnected with the output of the electrets and an indication output responsive to the alternating current voltage of the output of the electrets.

### BRIEF DESCRIPTION OF THE DRAWINGS

A full understanding of the disclosed concept can be gained from the following description of the preferred embodiments when read in conjunction with the accompanying drawings in which:

FIG. 1 is a block diagram of an indicator system including an electret, a rectifier, a capacitor and a electroluminescent indicator in accordance with embodiments of the disclosed concept.

FIG. 2 is a block diagram of a portion of an indicator system, which can be similar to the indicator system of FIG. 1, but including a contrasting background for the electroluminescent indicator.

FIG. 3 is a block diagram of an indicator system including an electret, a half-wave rectifier, a capacitor and a neon bulb in accordance with another embodiment of the disclosed concept.

FIG. 4 is a block diagram of an indicator system including an electret, a full-wave rectifier, a capacitor and a neon bulb in accordance with another embodiment of the disclosed concept.

FIG. 5 is a block diagram of a portion of an indicator system, which can be similar to the indicator system of FIG. 3, but including two parallel capacitors and a neon bulb.

FIG. 6 is a block diagram of an indicator system including an electret, a rectifier, a capacitor, a diac and a solid state electroluminescent indicator in accordance with another embodiment of the disclosed concept.

FIG. 7 is a block diagram of an indicator system including a plurality of electrets and an electroluminescent indicator in accordance with another embodiment of the disclosed concept.

### DESCRIPTION OF THE PREFERRED EMBODIMENTS

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

An “electret” is a dielectric material that has a permanent or quasi-permanent electric charge and/or dipole polarization, and also has piezoelectric characteristics. The electret dielectric material is typically metalized for electrical connectivity and is fabricated in such a fashion that an electric field exists within the dielectric material. The electret is the electrostatic equivalent of a permanent magnet. Electrets do not typically have the capability to generate much current but can be used to provide a reference potential difference. Non-limiting examples of electrets include electret devices, electret systems and electret material solutions.

As employed herein the term “switchgear device” shall expressly include, but not be limited by, a circuit interrupter, such as a circuit breaker (e.g., without limitation, low-voltage or medium-voltage or high-voltage); a motor controller/starter; a busway; and/or any suitable device which carries or transfers current from one place to another.

As employed herein the term “power bus” shall mean a power conductor; a power bus bar; a power line; a power phase conductor; a power cable; and/or a power bus structure for a power source, a circuit interrupter or other switchgear device, or a load powered from the power bus.

FIG. 1 shows an indicator system 2 for an alternating current (AC) power bus 4. The indicator system 2 includes an electret 6 operatively associated with the AC power bus 4. The electret 6 includes an output 8 having an AC voltage 10 when the AC power bus 4 is energized. The indicator system 2 also includes a rectifier, such as a suitable rectifier circuit 12, having an input 14 electrically interconnected with the output 8 of the electret 6 and an output 16 having a direct current (DC) voltage 18 (e.g., without limitation, pulsed DC; full wave rectified DC; full wave rectified and filtered DC) responsive to the AC voltage 10 of the output 8 of the electret 6, and an electroluminescent (EL) indicator 20 including an input 22 electrically interconnected with the output 16 of the rectifier circuit 12 and an indication output 23 responsive to the DC voltage 18 of the output 16 of the rectifier circuit 12.

As shown in FIG. 1, the power bus 4 (e.g., without limitation, a power bus bar or power conductor) is energized with an AC voltage 24 (with respect to a ground or neutral potential (not shown)). The electret 6 has two output terminals 26,28 for connection to the rectifier circuit 12. A number of capacitors 29 (only one capacitor 29 is shown in FIG. 1) are electrically connected in parallel with the input 22 of the EL indicator 20.

In this embodiment, the electret 6, which has a permanent, inherent electrostatic field (e.g., without limitation, when coupled to an adjacent energized AC power bus 4), provides a localized circuit ground potential from which subsequent circuitry can be referenced. When an AC field is present, the electret 6, which has a construction containing a dielectric sandwiched by metal contacts, will behave like a capacitor and will charge in the presence of the AC field to provide stored energy to the output 8. For example, the electret 6 has a combination of characteristics, such as permanent charge or dipole characteristics, and can have internal electric field storage similar to a capacitor. But since it also has piezoelectric characteristics, it can act in concert with a driving AC energizing voltage to be stressed through the internal electric field (capacitive) effect and then “rebound” through the piezoelectric effect to then generate the corresponding output AC voltage 10. The output voltage and current is determined by the strength of the AC field in the proximity of the electret 6, the duration that the electret 6 is present within the AC field, and the distance between the electret 6 and the field generating power bus 4. The output AC voltage 10 is converted to the output DC voltage 18 by the rectifier circuit 12. The output DC voltage 18 of the rectifier circuit 12 then can act on the EL indicator 20 to be powered using current or charge stored internally through the internal electret electric field in conjunction with the internal piezoelectric character by the electret 6 in the presence of the AC field. Use of the rectifier circuit 12 to convert the output AC voltage 10 of the electret 6 to the output DC voltage 18 of the rectifier circuit 12 is employed when the EL indicator 20 needs to be powered by DC voltage.

The electret 6, the rectifier circuit 12, the number of capacitors 29 and the EL indicator 20 are electrically “floating” with respect to the power bus 4. None of this is directly electrically connected to ground potential or to the bus bar potential, such that the interaction is through the power bus AC electric field. Depending on the physical arrangement, there can be parasitic capacitive-coupling-to-ground that may be involved; if so, that capacitance should be tailored to meet the needs of the equivalent circuit. The electret 6 is adjacent to or suitably proximate the power bus 4. The electret 6 is not actually electrically connected to the power bus 4, although it may be suitably mechanically attached or coupled thereto.

The electret 6 acts as a piezoelectric which also has a permanent charge/dipole. The electret 6 interacts with the generated AC electric field of the power bus 4. The electret output 8 provides an electret-generated AC voltage 10.

### Example 1

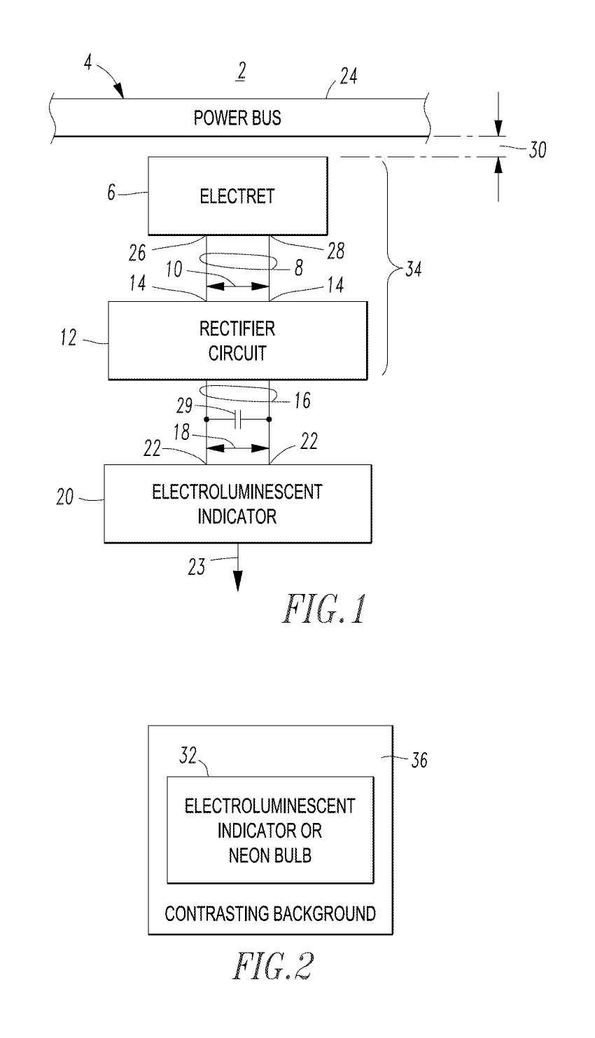

The EL indicator 20 can be a gas phase EL indicator, such as a neon illumination indicator (e.g., without limitation, a neon bulb 32 as is shown in FIGS. 2-4).

For a neon/gas phase EL indicator, the leads of the neon illumination indicator are electrically connected across the leads of an electret-rectifier energy harvesting system 34, as shown in FIG. 1. In addition, the capacitor 29 is also electrically connected across the leads (in parallel with the neon illumination indicator) of the electret-rectifier energy harvesting system 34. When the voltage 18 is applied to the parallel combination of the neon illumination indicator and the capacitor 29, from the electret-rectifier energy harvesting system 34, the voltage 18 increases from zero volts. Before this voltage 18 reaches a “turn-on” voltage level, the neon illumination indicator acts as an “electrical open” circuit of relatively high resistance and, thus, allows the capacitor 29 to be charged. When the voltage 18 reaches a sufficient level that can initiate the plasma inside the neon illumination indicator, the plasma “turns-on” and uses the charge that had been in the capacitor 29 to sustain itself. This illuminating plasma continues until the charge that had been built up in the capacitor 29 is depleted. At this point, the voltage 18 drops to an insufficient level that can no longer sustain the plasma, and the neon illumination indicator then turns off. At that point, the neon illumination indicator again acts as though it is an “electrical open” circuit of relatively high resistance, and the driving voltage 18 from the electret-rectifier energy harvesting system 34 again begins to build up the voltage 18 on the capacitor 29. The cycle continues like this, as long as the voltage 24 applied to the energized conductor 4 is present and can drive the electret-rectifier energy harvesting system 34.

An attribute of this illumination system is that the lighted neon illumination indicator blinks rather than just being on as a steady state light. From a human factors perspective, this blinking function aids in solving the problem of a safety indicator to a workman, technician or electrician who is near the energized conductor 4. The blink rate can be modified, for example, by changing the electrical capacitance of the charging capacitor 29. For example, relatively high values of capacitance will result in relatively lower blink rates, while relatively lower capacitance values will result in relatively higher blink rates. In addition, the blink rate for a fixed capacitance value may change depending on the voltage 18 across the capacitor 29. This feature may allow the system to perform as a voltage “level” indicator.

TABLE 1

| Capacitance | Bus Bar Voltage | Blink Cycle |
|---|---|---|
| (μF) | (V) | (S) |
| 0.001 | 100 | 0.25 |
| 0.001 | 750 | 0.13 |
| 0.001 | 300 | 0.10 |
| 0.0068 | 200 | 2 |
| 0.0068 | 250 | 1 |
| 0.0068 | 300 | 1 |
| 0.0082 | 200 | 2.5 |
| 0.0082 | 250 | 1.5 |
| 0.0082 | 300 | 1 |
| 0.01 | 200 | 2.5 |
| 0.01 | 250 | 1 |
| 0.01 | 300 | 1 |
| 0.022 | 200 | 4 |
| 0.022 | 250 | 2 |
| 0.022 | 300 | 1.5 |
| 0.033 | 200 | 4 |
| 0.033 | 250 | 2.5 |
| 0.033 | 300 | 1.5 |
| 0.047 | 200 | 3.5 |
| 0.047 | 250 | 2 |
| 0.047 | 300 | 1.5 |
| 0.068 | 200 | 8 |
| 0.068 | 250 | 4 |
| 0.068 | 300 | 3 |
| 0.082 | 200 | 20 |
| 0.082 | 250 | 11 |
| 0.082 | 300 | 7 |
| 0.1 | 200 | 24 |
| 0.1 | 250 | 12 |
| 0.1 | 300 | 8 |
| 0.22 | 200 | 18 |
| 0.22 | 250 | 10 |
| 0.22 | 300 | 6 |
| 0.47 | 200 | 60 |
| 0.47 | 250 | 30 |
| 0.47 | 300 | 20 |

### Example 2

As shown in FIG. 2, the illuminated EL indicator can be the example neon bulb 32 and preferably includes a contrasting background 36 behind or around, for example, the neon bulb 32 to make it more “visible” (e.g., without limitation, a black background behind a red, neon bulb indicator).

### Example 3

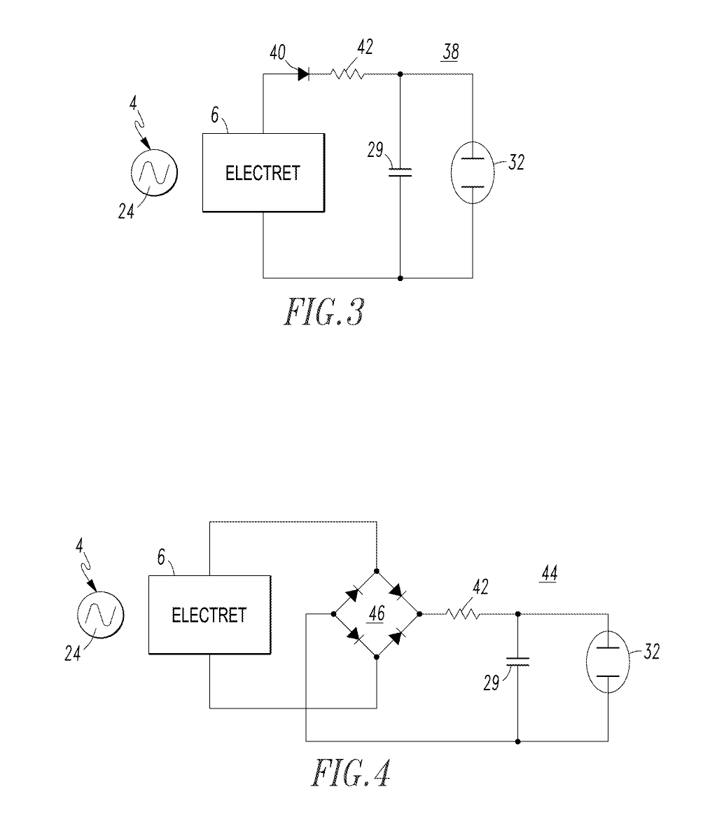

FIG. 3 shows another indicator system 38 in which a half-wave rectifier, such as the example diode 40, is employed with the AC source 24 on bus bar 4, the electret 6, an optional current limiting resistor 42, the parallel number of capacitors 29 and the neon bulb 32. The optional current limiting resistor 42 is electrically connected between the cathode of the diode 40 and the number of capacitors 29.

### Example 4

FIG. 4 shows another indicator system 44 in which a full-wave rectifier 46 is employed with the AC source 24 on bus bar 4, the electret 6, the optional current limiting resistor 42, the parallel number of capacitors 29 and the neon bulb 32. The optional current limiting resistor 42 is electrically connected between the full-wave rectifier 46 and the number of capacitors 29. This provides a relatively faster capacitor charging time, but is slightly more expensive than the system 38 of FIG. 3 in Example 3.

### Example 5

As an alternative to the single capacitor 29, as shown in FIGS. 3 and 4, in order to get better efficiency, two parallel capacitors 52 can be employed as shown in FIG. 5.

### Example 6

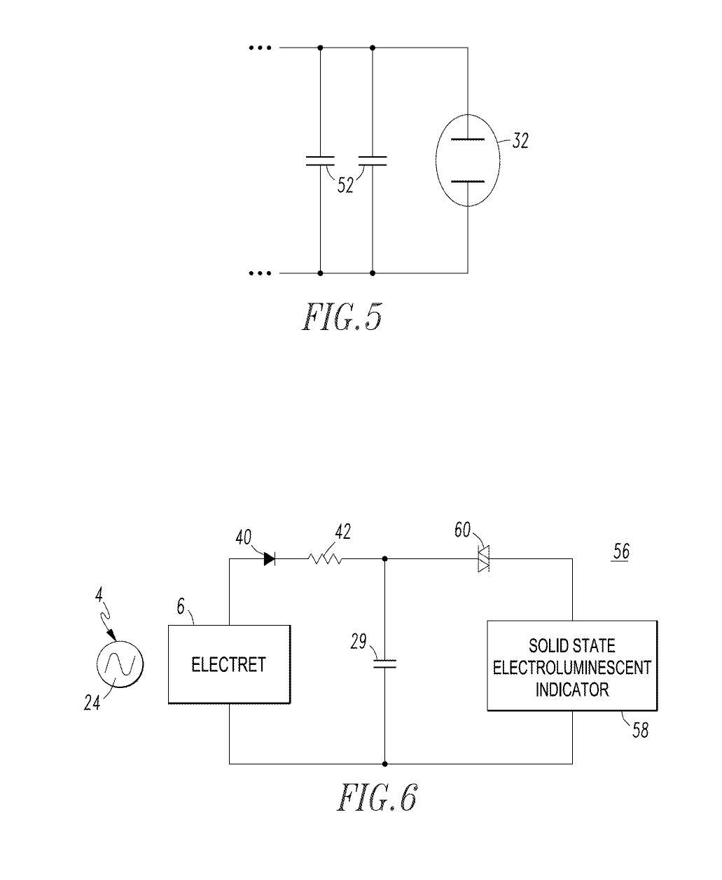

FIG. 6 shows another indicator system 56 in which a solid state EL indicator 58 is employed. The solid state EL indicator 58 can be, for example and without limitation, an EL wire, a planar EL, or an LED.

If the solid state EL 58 is an LED, then the LED can be substituted (with proper orientation) for the neon bulb 32 of FIGS. 3-5. The LED can also utilize the parallel capacitor 29 and probably needs to have the current limiting resistor 42. The system 56 includes the electret 6, a rectifier, such as the example diode 40, the optional current limiting resistor 42, the parallel number of capacitors 29, a diac 60 and the solid state EL indicator 58. The solid state EL indicator 58 is electrically connected in series with the diac 60.

As in the gas phase embodiment, the capacitor 29 charges up in voltage, through being supplied by the electret 6 and rectifier 40, and through a lack of leakage through the diac 60 and solid state EL indicator 58 because the diac 60 has not yet closed to allow current flow. Therefore, the voltage on the capacitor 29 is changing with time, but not in a sine fashion like in normal AC mode. Once the diac 60 sees the threshold turn-on voltage (as provided by the capacitor 29 that has been charging up all this time), it closes to allow current flow (from the capacitor 29) through the diac 60 and the series-connected solid state EL indicator 58. The diac 60 can be thought of as an AC diode in that it will conduct the AC only after it has reached the specified value (breakover voltage).

Similar to a neon illumination indicator, the solid state EL indicator 58 is driven by voltage provided by an electret-rectifier energy harvesting system, such as 34 of FIG. 1. Again, similar to FIG. 1, the number of capacitors 29 are electrically connected in parallel with the series combination of the diac 60 and the solid state EL indicator 58. But, in this example, to mimic an “electrical open” of relatively high resistance of a neon element, an additional element, the example diac 60, is electrically connected in series with the solid state EL indicator 58 and has the function of being a voltage-level-triggered switch. Although a diac is shown, any suitable voltage-level-triggered switch (e.g., without limitation, a gas electronics device; a suitable solid state device) can be employed. When the charged up voltage of the capacitor 29 reaches the switch threshold level, the voltage-level-triggered switch closes, and then the charge is able to flow through and illuminate the solid state EL indicator 58, until which time the voltage has dropped sufficiently to re-open the switch. The cycle continues, and the system 56 can similarly blink.

Unlike a technical challenge associated with solid state EL or gas phase EL, wherein the electric field strength generated by the applied conductor voltage 24 alone may or may not be of sufficient strength to “turn-on” the given EL indicator (i.e., there is a threshold “turn-on” electric field for the solid state EL indicator 58 or the gas phase EL indicator, such as the example neon bulb 32), the embodiment of FIG. 6 provides for a sufficient voltage to drive the desired illumination.

A non-limiting example of the solid state EL indicator 58 is a wire EL (e.g., model HBW, marketed by Glowire of LaOtto, Ind.) or a planar EL (e.g., Model MOQ, marketed by Top Right Optoelectronics, Ltd of Sai Ying Pun, Hong Kong).

### Example 7

An electret (as purchased) can contain electrical shielding structures which minimize coupling to a power line having a power line frequency (e.g., without limitation, 60 Hz) source. In the disclosed concept, it is desired to couple to an example 60 Hz source and, hence, the electret 6 does not include such shielding.

### Example 8

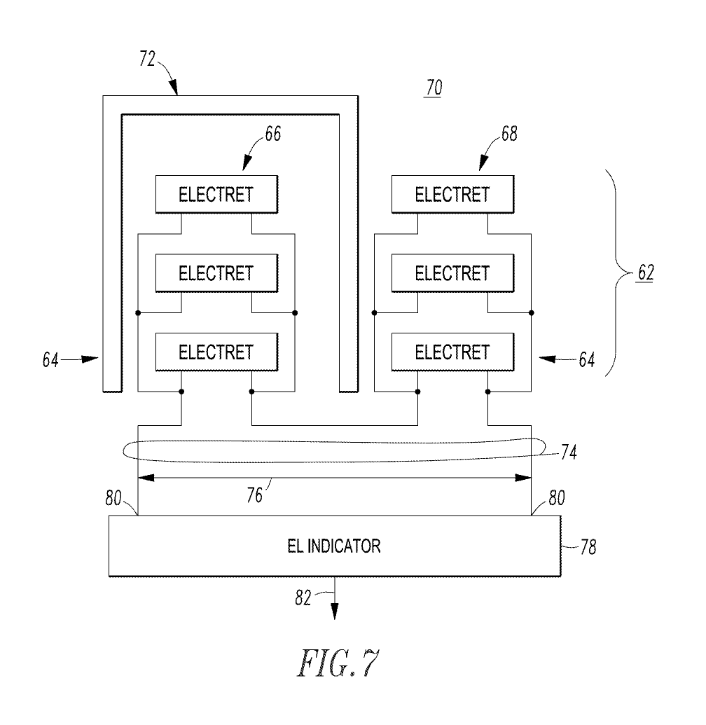

Preferably, a plurality of electrets 62 are “ganged” (e.g., a plurality of electrets 62; a stacked construction) as shown in FIG. 7 in order to provide a relatively larger source of generated voltage/current to drive the example EL indicator 78, such as an example neon bulb, sufficiently such that the boost capacitor 29 (FIGS. 1-4) is not needed (nor perhaps the rectifier circuit 12).

One example way of accomplishing this structure is to create a multilayer electret which would have alternating stacks of electret material and signal (electrode) layers similar to a multilayer capacitor. Using that as a corollary, they would be in parallel. Alternatively, the electret could be made as a relatively long strip and then folded to make a multi-layer device. This would create a stack of material which would react to the field (or even a mechanical strain if a static load is applied to it via something like a magnet) to generate more current from a given cross-sectional area. The multi-layer approach could use about two to five or up to about ten layers.

In this configuration, the electrets 62 can be a plurality of electret devices 64 electrically connected in series; or a plurality of first electret devices 66 electrically connected in parallel to form a first circuit, a plurality of second electret devices 68 electrically connected in parallel to form a second circuit, and the first and second circuits being electrically connected in series.

This provides an indicator system 70 for an alternating current power bus 72 including a plurality of the electrets 62 operatively associated with the alternating current power bus 72. The electrets 62 include an output 74 having an alternating current voltage 76 when the alternating current power bus 72 is energized. The EL indicator 78 includes an input 80 electrically interconnected with the output 74 of the electrets 62 and an indication output 82 responsive to the alternating current voltage 76 of the output 74 of the electrets 62.

The electrets 62 and the power bus 72 may be the same as or substantially similar to the respective electret 6 and the power bus 4 of FIG. 1. In FIG. 7, the EL indicator 78 needs to be powered by an AC voltage similar to what comes directly out of the electrets 62 when actuated by the AC power bus electric field. In this case, no rectifier circuit is employed. For the indicator system 70, the input 80 of the EL indicator 78 is powered directly from the AC voltage 76 of the output 74 of the “ganged” electrets 62. For the indicator system 2 of FIG. 1, the input 22 of the EL indicator 20 is powered indirectly through the rectifier circuit 12 from the AC current voltage 10 of the output 8 of the single electret 6.

### Example 9

The parallel capacitor 29 of FIGS. 3 and 4 functions as a charge storage device to provide energy to sufficiently illuminate the neon plasma. Without this component, there is insufficient energy coming from the electret 6 to energize the example neon bulb 32 directly. Using this approach, the neon bulb 32 can be turned on and off in a blinking fashion (e.g., providing a visual safety device) and the blink rate can be modified by changing the value of the capacitor 29 and/or the electret-enabled voltage level.

### Example 10

A non-limiting example of the electret 6 is an S-series sensor manufactured by the EMFIT Ltd. of Vaajakoski, Finland or Emfit, Corp. of Austin, Tex.

### Example 11

The number of capacitors 29 has a selected capacitance value as was discussed, above, in connection with Example 1. The EL indicator 20 of FIG. 1 is structured to blink at a frequency related to the selected capacitance value when the alternating current power bus 4 is energized.

The optional current limiting resistor 42 of FIGS. 3 and 4 can be employed to suitably control the current during the blink event. If this is not done, then there is a risk that the plasma in the neon bulb 32 transitions over from normal plasma to plasma-plus-arc, if the current gets too high. The luminance does not significantly change (to the human eye) when this happens, however, if the neon bulb 32 is running too much in this mode, then this can cause it to (significantly) sputter away electrode material prematurely and lose life.

An upside to having the current limiting resistor 42 (besides the improved neon bulb life) is that the blink event should take longer to run out. This increased blink on-time will allow the human eye to integrate longer and the appearance of the blink luminance will be apparently brighter (than it actually might be measured to be), which is a good result.

### Example 12

The electret 6 of FIG. 1 may be an electret device. If a gap 30 is employed between the power bus 4 and the electret 6, then the gap distance is not critically important. However, the closer the electret 6 is to the bus bar 4, the more electric field can be harvested in order to provide more power output. The overall electret device could be physically attached to the power bus 4 (e.g., without limitation, employing adhesive, a bolt or a clamp), in order to position it as close to the power bus 4 as possible in order to harvest relatively more electric field. The electret 6 converts the AC electric field to the output AC voltage 10 in a robust yet passive manner.

### Example 13

The electret 6 may be made of an electret material solution packaged within, for example and without limitation, a molded housing (not shown).

### Example 14

The electret 6 may be made from a material selected from the group consisting of an organic polymer electret material, and an inorganic electret material, although a wide range of electret materials can be employed (e.g., without limitation, other organic materials; other inorganic materials).

### Example 15

The electret 6 may be coupled to the AC power bus 4.

### Example 16

The rectifier circuit 12 is selected from the group consisting of a diode, a full-wave bridge, and an integrated device, although any suitable rectifier circuit 12 can be employed, such as another equivalent circuit or discrete hardware. The rectifier circuit 12 converts the AC output voltage 10 from the electret 6 into a DC output voltage 18 for the DC EL indicator 20.

### Example 17

The EL indicator 20 is powered responsive to the DC voltage 18 of the output 16 of the rectifier circuit 12 when the AC power bus 4 is energized.

### Example 18

Further to Example 17, the AC power bus 4 has an alternating current flowing therethrough.

### Example 19

Further to Example 17, zero current flows through the AC power bus 4.

### Example 20

The indicator system 2 of FIG. 1 provides a safety function for, for example and without limitation, electrical control enclosures (e.g., without limitation, motor control centers (MCCs)) by indicating (e.g., without limitation, to a maintenance worker, electrician or technician) (e.g., without limitation, through a suitably high-contrast indicator) that the power bus 4 has been energized (e.g., by an applied AC voltage, even though electrical current is not necessarily flowing or regardless whether a load is electrically connected). The disclosed concept provides an indicator to alert people about an energized power bus and therefore avoid accidental or unaware-based contact that could otherwise cause severe injury or death.

### Example 21

The indicator system 2 of FIG. 1 makes use of the AC electric field that is generated in the space around the power bus 4 that is energized. This employs the generated electric field to “turn-on” the electret 6 that is susceptible to the electric field. The electret 6 is held in a structure that allows for the electric field of the energized power bus 4 to interact with the self-charged, self-field of the electret in a manner that actuates the electret. For example and without limitation, in combination with the suitable EL indicator 20, this allows for a non-lighted, high-contrast visual indication of “turn-on” status.

### Example 22

The indicator system 2 of FIG. 1 harvests energy from an AC power bus electric field through use of the electret 6. The charge of the electret 6 is acted on by the AC electric field to stress the electret matrix, which in turn responds through its piezoelectric characteristics to output a corresponding AC voltage 10, which actuates the EL indicator 20 to provide an indication of the energized AC power bus 4.

### Example 23

The indicator system 2 of FIG. 1 generates useable energy from the energized power bus 4 (e.g., by an applied voltage even though electrical current is not necessarily flowing or regardless whether a load is electrically connected) and employs the same to provide an indication of the energized AC power bus 4.

### Example 24

The indicator system 2 of FIG. 1 interacts with the energized power bus 4 through an electric field as opposed to a magnetic field that is generated if current is flowing through the power bus 4. Hence, this solves the problem of monitoring an energized power bus even if current is not flowing (e.g., without limitation, a downstream circuit breaker is open; the downstream load is disconnected). This advantageously provides a very beneficial result since an energized power bus could have a voltage (and an associated electric field) present without having current flowing and still be a danger to a person who accidentally touched or approached the power bus.

### Example 25

The equivalent circuit of the indicator system (e.g., without limitation, indicator system 2 of FIG. 1, indicator system 38 of FIG. 3, indicator system 44 of FIG. 4, indicator system 56 of FIG. 6, or indicator system 70 of FIG. 7) interacts with the outside world through a parasitic capacitance (through the air) to ground (depending on the physical arrangement). That parasitic capacitance would be tailored to meet the needs of the equivalent circuit.

### Example 26

The electret 6 can be a stand-alone device in electrical communication with the rectifier circuit 12 and/or the EL indicator 20 (and any associated electronics (not shown)). Alternatively, the electret 6 can be part of a molded or a conventional housing (not shown) which contains some or all of the rectifier circuit 12 and/or the EL indicator 20 (and any associated electronics (not shown)). The EL indicator 20 is actuated by the DC output voltage 18 of the rectifier circuit 12. The EL indicator 20 may be coupled in a flexible manner to the housing in such a way that the viewing angle can be adjusted to improve detectability and to allow the user to view from a suitable distance if the depth of the electrical cabinet (not shown) is deeper or if the other items within the cabinet (e.g., without limitation, load wiring) tend to obstruct the nominal view.

The disclosed concept provides a safety feature to, for example, electrical control enclosures (e.g., without limitation, motor control centers) by having an illuminated EL indicator visually indicate to a maintenance worker or electrician or technician that a conductor has been energized (by applied voltage even though electrical current is not necessarily flowing or that a load is electrically connected). For example, inside of electrical control enclosures, there are busway conductors and lugged cable connection conductors, as well as conductor taps for three phase power (e.g., low voltage; medium voltage). The illuminated EL indicator provides for a visual indication (e.g., without limitation, through a lighted-brightness or high-contrast indicator) that signals that a given electrical conductor has a voltage applied to it (i.e., the conductor is energized), even though a load may not be connected or that current may not be flowing. The disclosed concept makes use of the electric field that is generated in the space around the conductor that is energized. The generated electric field “turns-on” a device or material that is susecptible to the electric field, for example, a gas phase EL device or EL material solution, such as using a neon or neon-xenon gas mixture that electroluminesces in the electric field. The device or material can be an electret device, an electret system or an electret material solution.

The electret can be held in a structure that allows for the electric field of the energized conductor to interact with the electret's self-charged, self-field in a manner that actuates the electet in combination with the illuminated EL indicator to allow for a lighted high-contrast visual indication of “turn-on” status. The voltage generated within the electret (when coupled to the adjacent electric field conductor) is converted from AC to DC through the use of a rectifier circuit.

The illuminated indicator can have the equivalent circuit characteristics of a capacitor that is charged through the use of the rectified voltage. The illuminated indicator can be a gas phase EL illumination device or a solid state EL illumination device.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. An indicator system for an alternating current power bus, said indicator system comprising:
an electret operatively associated with said alternating current power bus, said electret comprising an output having an alternating current voltage when said alternating current power bus is energized;
a rectifier comprising an input electrically interconnected with the output of said electret and an output having a direct current voltage responsive to the alternating current voltage of the output of said electret;
an electroluminescent indicator comprising an input electrically interconnected with the output of said rectifier and an indication output responsive to the direct current voltage of the output of said rectifier; and
a number of capacitors electrically connected in parallel with the input of said electroluminescent indicator.

2. The indicator system of claim 1 wherein a contrasting background is disposed behind or around said electroluminescent indicator.

3. The indicator system of claim 1 wherein said electret is selected from the group consisting of a plurality of electret devices electrically connected in parallel; a plurality of electret devices electrically connected in series; and a plurality of first electret devices electrically connected in parallel to form a first circuit, a plurality of second electret devices electrically connected in parallel to form a second circuit, and said first and second circuits being electrically connected in series.

4. The indicator system of claim 1 wherein said electroluminescent indicator is a gas phase electroluminescent indicator.

5. The indicator system of claim 4 wherein said gas phase electroluminescent indicator is a neon illumination indicator.

6. The indicator system of claim 1 wherein said electroluminescent indicator is a solid state electroluminescent indicator.

7. The indicator system of claim 1 wherein said electroluminescent indicator is a solid state electroluminescent indicator electrically connected in series with a diac.

8. The indicator system of claim 7 wherein said solid state electroluminescent indicator is a wire electroluminescent indicator.

9. The indicator system of claim 7 wherein said solid state electroluminescent indicator is a planar electroluminescent indicator.

10. The indicator system of claim 1 wherein said alternating current power bus has a power line voltage with a power line frequency; and wherein said electret is not shielded from the power line frequency of the power line voltage.

11. The indicator system of claim 1 wherein said rectifier is a half-wave rectifier.

12. The indicator system of claim 11 wherein said half-wave rectifier is a diode.

13. The indicator system of claim 1 wherein said rectifier is a full-wave rectifier.

14. The indicator system of claim 1 wherein said number of capacitors is a plurality of parallel capacitors.

15. The indicator system of claim 1 wherein said rectifier is a half-wave rectifier; and wherein said number of capacitors is a plurality of parallel capacitors.

16. The indicator system of claim 1 wherein said number of capacitors has a selected capacitance value; and wherein said electroluminescent indicator is structured to blink at a frequency related to said selected capacitance value when said alternating current power bus is energized.

17. The indicator system of claim 1 wherein a current limiting resistor is electrically connected between said rectifier and said number of capacitors.

18. The indicator system of claim 1 wherein a current limiting resistor is electrically connected between said rectifier and said electroluminescent indicator.

19. The indicator system of claim 1 wherein a parasitic capacitance electrically couples between said indicator system and a ground corresponding to said alternating current power bus.

20. The indicator system of claim 1 wherein a parasitic capacitance electrically couples between said indicator system and an electrical ground.

21. The indicator system of claim 1 wherein said electret is coupled to said alternating current power bus.

22. The indicator system of claim 21 wherein said alternating current power bus has an alternating current flowing therethrough.

23. The indicator system of claim 21 wherein zero current flows through said alternating current power bus.

24. An indicator system for an alternating current power bus, said indicator system comprising:
a plurality of electrets operatively associated with said alternating current power bus, said electrets comprising an output having an alternating current voltage when said alternating current power bus is energized; and
an electroluminescent indicator comprising an input electrically interconnected with the output of said electrets and an indication output responsive to the alternating current voltage of the output of said electrets.
